(19) United States
(12) Patent Application Publication
(10) Pub. No.: US 2003/0177587 A1
(43) Pub. Date: Sep. 25, 2003

(54) Multifunctional peeling pliers

(75) Inventors: Chih-Lang Wang, Tu Cheng City (TW); Chien-Chou Liao, Tu Cheng City (TW)

Correspondence Address: BACON & THOMAS, PLLC, 625 SLATERS LANE, FOURTH FLOOR, ALEXANDRIA, VA, 22314

(73) Assignee: Hanlong industrial Co., Ltd., Taipei Hsien (TW)

(21) Appl. No.: 10/102,644

(22) Filed: Mar. 22, 2002

(51) Int. Cl. B25F 1/00

(52) U.S. Cl. 7/107

(57) ABSTRACT

A pair of multifunctional peeling pliers of which a pair of mutually confronting cutting blades are provided on the handles of the pliers, the pliers are provided with a plurality of peeling knives and wire receiving recesses having suitable spaces respectively from the cutting blades of the handles; and a spring is provided between the handles of the pliers. Thereby, the whole pliers can be used to cut wires by means of the cutting blades and to practice peeling of a coating layer of a wire taking advantage of the section on one of the handles having the peeling knives and wire receiving recesses. And when the pliers are not in use, the handles of the pliers can be in the closing state normally by the action of the spring to avoid exposure of blades of the cutting knife and the peeling knives and to increase safety of the entire pliers.

### BACKGROUND OF THE INVENTION

1. Field of the Invention

The present invention is related to a pair of multifunctional peeling pliers, and especially to the structure of such a pair of peeling pliers with which cutting of a signal line, peeling of a coating layer, peeling of an insulating layer and fixed connecting of a connector by pressing can be completed. The handles of the pliers are provided therebetween with a spring to make the handles be closed to each other in the normal state, in order to avoid exposure of blades of the cutting knife and the peeling knives of the pliers and to increase safety of the entire pliers.

2. Description of the Prior Art

In conventional electric wire distributing operation of coaxial cables, lengths of cables are cut in pursuance of the real situation in site, and cutting for tidiness, peeling of the cables, peeling of an insulating layer and finally fixed connecting of a connector by pressing of the cables are proceeded to in the subsequent operation. Therefore, during the entire electric wire distributing operation, tools including a pair of cutting pliers, a pair of peeling pliers and a pair of press connecting pliers etc. shall be utilized respectively. This not only influences the rate of progress in operation by the cumbersome changing of tools, but also increases the cost of outfit by the requirement of purchasing such a plural kinds of tools.

Moreover, when the site of operation is at a high location, in the cumbersome operation of changing tools, the tools are subjected to dropping by inadvertent loosening of a hand, and even sometimes accidents and damages can be induced. Particularly, the blades of the knives of a pair of pliers are generally separated to form an opening state when the user of the pliers does not exert force on the handles of the pliers, the user is subjected to hurting by the handles in taking the pliers.

### SUMMARY OF THE INVENTION

Thereby, the primary object of the present invention is to provide a pair of multifunctional peeling pliers of which a pair of mutually confronting cutting blades are provided on the handles of the pliers, and to provide a plurality of peeling knives and wire receiving recesses having suitable spaces respectively from the cutting blades of the handles; and a spring is provided between the handles of the pliers. Thereby, the whole pliers can be used to cut wires by means of the cutting blades and to practice peeling of a coating layer of a wire taking advantage of the section on one of the handles having the peeling knives and wire receiving recesses. And when the pliers are not in use, the handles of the pliers can be in the closing state normally by the action of the spring to avoid exposure of blades of the cutting knife and the peeling knives and to increase safety of the entire pliers.

Another object of the present invention is to provide notches in opposition to the wire receiving recesses and on the side of a handle having the peeling knives to limit the depth that the corresponding one of the peeling knives may extend into the coating of a wire.

A further object of the pair of multifunctional peeling pliers of the present invention is to provide a receiving indent on the blade of each peeling knife to have the core of a wire held therein for avoiding cutting the core, and thereby peeling of an insulating layer on the wire can be effected.

Another object of the multifunctional peeling pliers of the present invention is to provide in a suitable location on the handles with a clamping mouth to fixedly press connect a wire with a connector.

The present invention will be apparent after reading the detailed description of the preferred embodiment thereof in reference to the accompanying drawings.

### BRIEF DESCRIPTION OF THE DRAWINGS

FIG. 1 is a perspective view showing the structure of the multifunctional peeling pliers of the present invention;

FIG. 2 is a schematic view showing the close state of the handles of the pliers of the present invention;

FIG. 3 is a schematic view showing use of the pliers of the present invention in wire cutting;

FIG. 4 is a schematic view showing use of the pliers of the present invention in peeling of the coating layer of a wire;

FIG. 5 is a schematic view showing the process of action in peeling the coating layer of the wire of the pliers of the present invention;

FIG. 6 is a schematic view showing use of the pliers of the present invention in peeling the insulating layer of the wire;

FIG. 7 is an enlarged schematic view showing the cutting blades of the pliers of the present invention.

### DETAILED DESCRIPTION OF THE PREFERRED EMBODIMENT

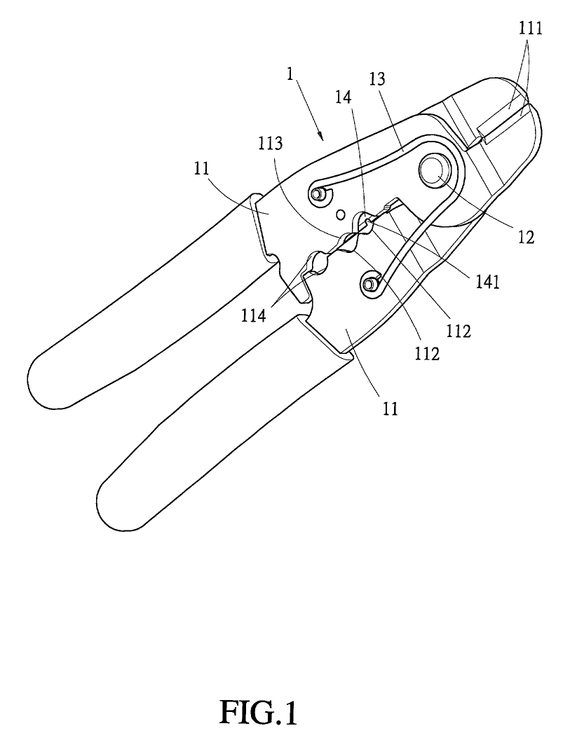

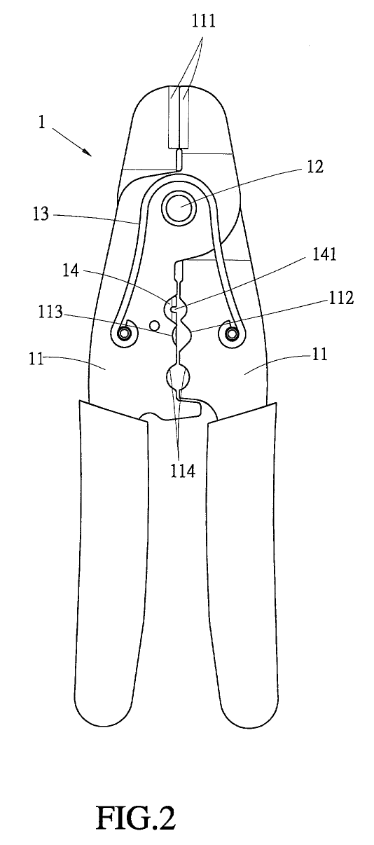

Referring to FIGS. 1 and 2, the multifunctional peeling pliers of the present invention has a pivot axle 12 to connect two mutually confronting handles 11 to render the latter to be able to open and close within an appropriate extent; the handles 11 are provided at suitable locations thereon with two mutually confronting cutting blades 111, and are provided at locations having suitable spaces respectively from the cutting blades 111 on the handles 11 with a plurality of peeling knives 14 and wire receiving recesses 112. A spring 13 is provided between the handles 11 of the pliers 1, so that the spring 13 between the handles 11 can form a suitable clamping force to make the handles 11 closed normally when the pliers 1 are not in use, to thereby avoid exposure of the blades of the cutting knife and the peeling knives and to increase safety of the entire pliers.

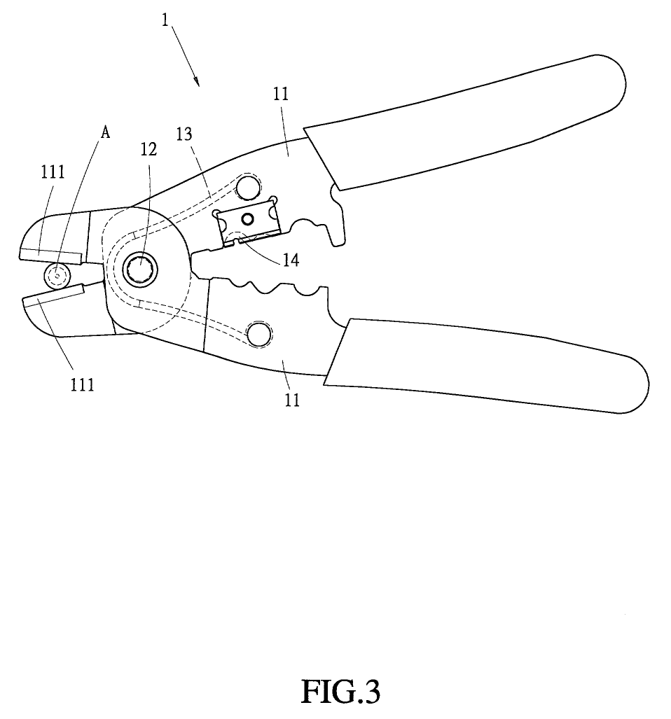

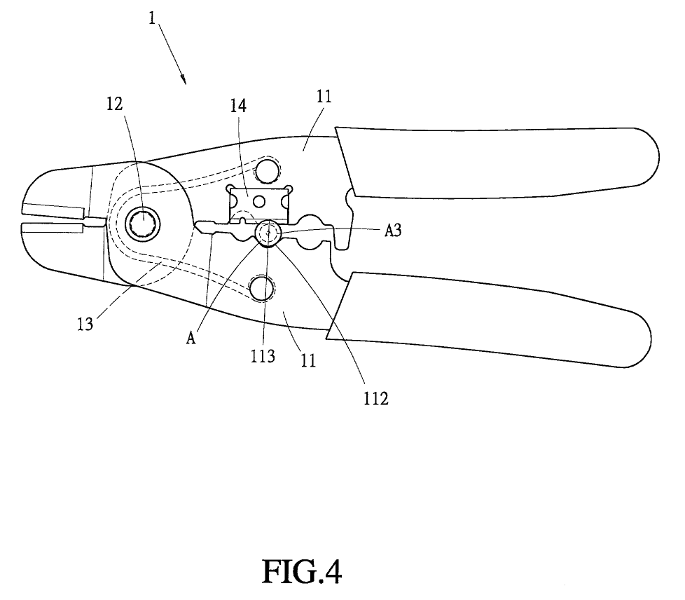

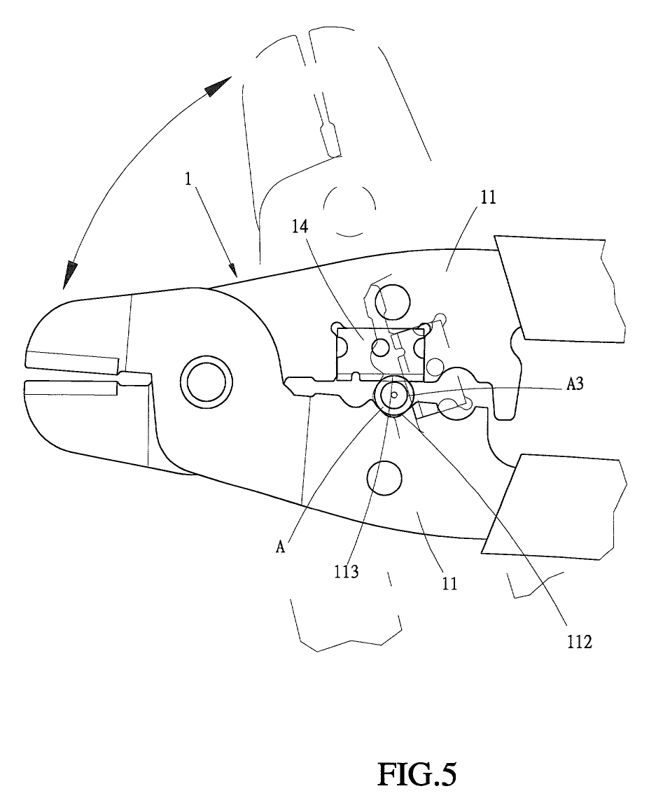

As shown in FIG. 3, the whole pliers 1 can be used to cut a wire “A” by means of the cutting blades 111, or as shown in FIG. 4, to practice peeling of a coating layer of the wire “A” taking advantage of the section on one of the handles having the peeling knives 14 and wire receiving recesses 112. Wherein, the pliers 1 are provided on the side of a handle 11 having the peeling knives 14 with notches 113 in opposition to the wire receiving recesses 112 to limit the depth that the corresponding one of the peeling knives 14 may extend into the coating A3 of the wire “A”. Thereby, when in peeling the coating A3 of the wire “A”, the wire “A” can be placed in one of the wire receiving recesses 112, the handles 11 get close to each other by the action of the spring 13 to render the peeling knife 14 to pierce the coating A3 of the wire “A”. And as shown in FIG. 5, the user rotates the pliers 1 or the wire “A” to make an annular cutting on the coating A3 of the wire “A” with the peeling knife 14, and finally, the pliers 1 are drawn out toward the tailing end of the wire “A”, and the coating A3 can be easily peeled off.

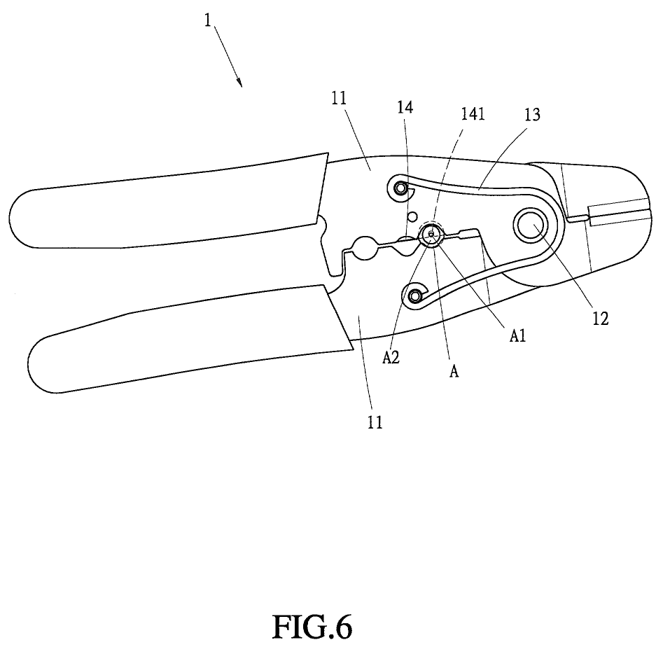

Moreover, as shown in FIGS. 2 and 6, the pliers 1 can be provided with a receiving indent 141 on the blade of the peeling knife 14, so that when the coating is peeled, the wire “A” can be placed in another corresponding wire receiving recess 112, when the handles 11 get close to each other by the force exerted by the user, the peeling knife 14 pierces an insulation layer A2 of the wire “A”. The core A1 of the wire “A” is placed in the receiving indent 141 to avoid breakage of the core A1 by cutting; and similarly, the user rotates the pliers 1 or the wire “A” to make an annular cutting on the insulation layer A2 of the wire “A” with the peeling knife 14, and finally, the pliers 1 are drawn out toward the tailing end of the wire “A”, and the insulation layer A2 can be easily peeled off.

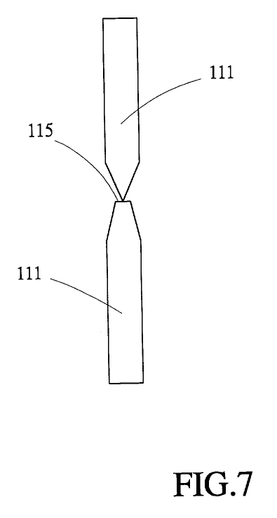

The pliers 1 can also be provided at a suitable location on the handles 11 with a clamping mouth 114 to fixedly press connect the wire “A” with a connector. And as shown in FIG. 7, the cutting blades 111 of the pliers of the present invention are arranged in a mode of mutually opposing, the edge of one of the cutting blades 111 forms a slight truncated head 115 to make sure that the blades 111 can contact with each other, and thereby the cutting blades 111 can surely pierce the coating of the wire.

The multifunctional peeling pliers of the present invention provides mutually confronting cutting blades at suitable locations, and provides a plurality of peeling knives and wire receiving recesses having suitable spaces respectively from the cutting blades of the handles; and a spring is provided between the handles of the pliers. Thereby, the whole pliers can be used to cut wires by means of the cutting blades and to practice peeling of a coating layer of a wire taking advantage of the section on one of the handles having the peeling knives and wire receiving recesses. And when the pliers are not in use, the handles of the pliers can be in the closing state normally by the action of the spring to avoid exposure of blades of the cutting knife and the peeling knives and to increase safety of the entire pliers. A preferred structure of peeling pliers thus is provided. Therefore, what I claim as new and desire to be secured by Letters Patent of the United States are:

1. A pair of multifunctional peeling pliers having a pivot axle to connect two mutually confronting handles to render said handles to be able to open and close within a predetermined extent, said handles are provided thereon with mutually confronting cutting blades, said peeling pliers are characterized by: said handles are provided at locations spaced respectively from said cutting blades on said handles with a plurality of peeling knives and wire receiving recesses, a spring is provided between said handles of said pliers; thereby, said pliers is used to cut wires by said cutting blades and to practice peeling of a coating layer of a wire taking advantage of a section on one of said handles having said peeling knives and wire receiving recesses; and when said pliers are not in use, said handles of said pliers is in the closing state normally by the action of said spring to avoid exposure of blades of said cutting knife and said peeling knives and to increase safety of the entire pliers; when in peeling of the coating layer of said wire, said handles get close to each other by the action of said spring to render said peeling knife to pierce said coating of said wire.

2. The multifunctional peeling pliers as defined in claim 1, wherein, said pliers are provided with notches in opposition to said wire receiving recesses and on the side of one of said handles having said peeling knives to limit the depth that the corresponding one of said peeling knives may extend into said coating of said wire.

3. The multifunctional peeling pliers as defined in claim 1, wherein, a receiving indent is provided on the blade of each of said peeling knives to have the core of said wire held therein for avoiding cutting said core, and thereby peeling of an insulating layer on said wire is effected.

4. The multifunctional peeling pliers as defined in claim 1, wherein, a clamping mouth is provided between said handles to fixedly press connect said wire with a connector.

5. The multifunctional peeling pliers as defined in claim 1, wherein, said cutting blades of said pliers are arranged in a mode of mutually opposing, the edge of one of said cutting blades forms a slight truncated head to make sure that said blades contact with each other, and thereby said cutting blades surely pierce said coating layer of said wire.
